(19) United States
(12) Patent Application Publication
(10) Pub. No.: US 2025/0392915 A1
(43) Pub. Date: Dec. 25, 2025

(54) MANAGING A MAINTENANCE PROCESS IN A MOBILE NETWORK

(71) Applicant: International Business Machines Corporation, Armonk, NY (US)

(72) Inventors: Maja Curic, Munich (DE); Sagar Tayal, Ambala City (IN); Alecio Pedro Delazari Binotto, Munich (DE)

(21) Appl. No.: 18/825,000

(22) Filed: Sep. 5, 2024

(30) Foreign Application Priority Data
Jun. 24, 2024 (GB) GB2408988.0

(51) Int. Cl. H04W 12/122

(52) U.S. Cl. CPC H04W 12/122

(57) ABSTRACT

Approaches described herein relate to a method of managing a maintenance process in a mobile network comprising, by a centralized entity of the mobile network, receiving from a first distributed entity configured for maximizing its QoS by operating the maintenance process a QoS-related control-level report; based on the control-level report, determining a first QoS status of the first distributed entity; in response to a mobile device handed over from the first to a second distributed entity: based on a user-level report related to the first distributed entity's QoS and received from the mobile device, determining a second QoS status of the first distributed entity; if the second QoS status indicates a QoS issue, identifying a manipulation condition of the maintenance process based on the first QoS status, and if the manipulation condition indicates a potential manipulation of the maintenance process, triggering a cleanup routine for removing the potential manipulation.

### BACKGROUND

Approaches described herein relate to detecting and removing a potential manipulation of a maintenance process related to a distributed entity of a mobile network.

Operations in mobile telecommunications networks have grown to assume increasing levels of automation in new state-of-the-art architectures such as Open Radio Access Network (O-RAN). To accommodate emerging use cases, a mobile network may be organized in layers: a centralized layer featuring a comprehensive central control entity (e.g., a non-real time radio intelligent controller (non-RT RIC) in O-RAN) hosting centralized maintenance algorithms responsible for end-to-end operations; and a distributed layer, with multiple distributed control entities hosting distributed maintenance algorithms (e.g., near-real time radio intelligent controllers (near-RT RICs) in O-RAN) dedicated to specific domains, all coordinated by the central control entity. Automated maintenance processes may include artificial-intelligence (AI) algorithms, and more specifically, machine-learning (ML) algorithms.

Automated maintenance processes in mobile network may be largely data-driven. This may include collecting data from the network and feeding that data to centralized and distributed maintenance algorithms (e.g., rApps running on non-RT RICs and xApps running on near-RT RICs) that make decisions about network updates to accommodate occurring changes. In consequence, the network may become vulnerable to data poisoning attacks, which can happen on central and distributed sites as well and may result in unnecessary maintenance actions. In turn, the quality of service (QOS) may degrade.

The scientific publication “Mitigating Smart Jammers in MU-MIMO via Joint Channel Estimation and Data Detection” by G. Marti and S. Studer, ICC 2022—IEEE International Conference on Communications, Seoul, Republic of Korea, 2022, pp. 1336-1342, doi: 10.1109/ICC45855.2022.9838542 proposes a method for mitigating attacks by smart jammers on massive multi-user multiple-input multiple-output base stations. The presented approach builds on progresses in joint channel estimation and data detection (JED) and exploits the fact that a jammer cannot change its subspace within a coherence interval. The proposed method named MAED uses a problem formulation that combines jammer estimation and mitigation, channel estimation, and data detection, instead of separating these tasks. The authors suggest to solve the problem approximately with an iterative algorithm. Simulation results are presented showing that MAED may mitigate a wide range of smart jamming attacks without having any a priori knowledge about the attack type.

The scientific publication “Poisoning Bearer Context Migration in O-RAN 5G Network” by S. Soltani et al., IEEE Wireless Communications Letters, vol. 12, no. 3, pp. 401-405, March 2023, doi: 10.1109/LWC.2022.3227676 introduces an attack type named Bearer Migration Poisoning (BMP) that misleads the RIC into triggering a malicious bearer migration procedure. The adversary aims to change the user level traffic path and causes significant network anomalies such as routing blackholes. BMP may allow even a weak adversary with only two compromised hosts to launch the attack without compromising the RIC, RAN components, or applications. Numerical results are presented showing that the attack may impose a dramatic increase in signalling cost by approximately 10 times. Further, experimental results are presented showing that the attack may significantly degrade the downlink and uplink throughput to nearly 0 Mbps, seriously impacting the service quality and end-user experience.

### SUMMARY

One aspect relates to a computer-implemented method of managing a maintenance process in a mobile network, the mobile network comprising a centralized entity and distributed entities, the distributed entities controlling edge nodes configured for registering mobile devices with the mobile network, the method comprising, by the centralized entity:
receiving from a first one of the distributed entities a control-level report related to a quality of service, QoS, of the first distributed entity, the first distributed entity being configured for maximizing the QoS of the first distributed entity by operating the maintenance process;
based on the control-level report, determining a first QoS status of the first distributed entity;
in response to registration of a mobile device being handed over from a first edge node controlled by the first distributed entity to a second edge node controlled by a second one of the distributed entities:
   based on a user-level report related to the QoS of the first distributed entity and received from the mobile device, determining a second QoS status of the first distributed entity;
   if the second QoS status is indicative of a predefined QoS issue, identifying a manipulation condition of the maintenance process based on the first QoS status, and if the manipulation condition indicates a potential manipulation of the maintenance process, triggering a cleanup routine configured for removing the potential manipulation based on the manipulation condition.

A further aspect relates to a computer program product for managing a maintenance process in a mobile network, the mobile network comprising a centralized entity and distributed entities, the distributed entities controlling edge nodes configured for registering mobile devices with the mobile network, the computer program product comprising a computer readable storage medium having program instructions embodied therewith, the program instructions being executable by the centralized entity to cause the centralized entity to perform a method comprising:
receiving from a first one of the distributed entities a control-level report related to a quality of service, QoS, of the first distributed entity, the first distributed entity operating the maintenance process;
based on the control-level report, determining a first QoS status of the first distributed entity;
in response to registration of a mobile device being handed over from a first edge node controlled by the first distributed entity to a second edge node controlled by a second one of the distributed entities:
   based on a user-level report related to the QoS of the first distributed entity and received from the mobile device, determining a second QoS status of the first distributed entity;
   if the second QoS status is indicative of a predefined QoS issue, identifying a manipulation condition of the maintenance process based on the first QoS status, and if the manipulation condition indicates a potential manipulation of the maintenance process, triggering a cleanup routine configured for removing the potential manipulation based on the manipulation condition.

A further aspect relates to a computing device being configured as a centralized entity of a mobile network, the mobile network further comprising distributed entities controlling edge nodes of the mobile network, the edge nodes being configured for registering mobile devices with the mobile network, the computing device comprising a processor and a memory, the memory storing program instructions which, when executed by the processor, cause the computing device to perform a method of managing a maintenance process in the mobile network, the method comprising:
receiving from a first one of the distributed entities a control-level report related to a quality of service, QoS, of the first distributed entity, the first distributed entity operating the maintenance process;
based on the control-level report, determining a first QoS status of the first distributed entity;
in response to registration of a mobile device being handed over from a first edge node controlled by the first distributed entity to a second edge node controlled by a second one of the distributed entities:
   based on a user-level report related to the QoS of the first distributed entity and received from the mobile device, determining a second QoS status of the first distributed entity;
   if the second QoS status is indicative of a predefined QoS issue, identifying a manipulation condition of the maintenance process based on the first QoS status, and if the manipulation condition indicates a potential manipulation of the maintenance process, triggering a cleanup routine configured for removing the potential manipulation based on the manipulation condition.

A further aspect relates to a computer-implemented method of operating a mobile communications device, the method comprising, by the mobile communications device: operating a communications link to a mobile network via edge nodes of the mobile network; collecting diagnostic data related to related to the communications link;
maintaining the communications link by performing a handover from a first one of the edge nodes to a second one of the edge nodes, the first edge node being controlled by a first distributed entity of the mobile network, the second edge node being controlled by a second distributed entity of the mobile network;
in response to the handover, generating a user-level report containing a portion of the diagnostic data being related to the operation of the communications link via edge nodes controlled by the first distributed entity; and
transmitting the user-level report to a centralized entity of the mobile network via the second distributed entity.

A further aspect relates to a computer program product comprising a computer readable storage medium having program instructions embodied therewith, the program instructions being executable by a mobile communications device to cause the mobile communications device to perform a method comprising:
operating a communications link to a mobile network via edge nodes of the mobile network;
collecting diagnostic data related to related to the communications link;
maintaining the communications link by performing a handover from a first one of the edge nodes to a second one of the edge nodes, the first edge node being controlled by a first distributed entity of the mobile network, the second edge node being controlled by a second distributed entity of the mobile network;
in response to the handover, generating a user-level report containing a portion of the diagnostic data being related to the operation of the communications link via edge nodes controlled by the first distributed entity; and
transmitting the user-level report to a centralized entity of the mobile network via the second distributed entity.

A further aspect relates to a computing device being configured as a mobile communications device, the computing device comprising a processor and a memory, the memory storing program instructions which, when executed by the processor, cause the computing device to perform a method comprising:
operating a communications link to a mobile network via edge nodes of the mobile network;
collecting diagnostic data related to related to the communications link;
maintaining the communications link by performing a handover from a first one of the edge nodes to a second one of the edge nodes, the first edge node being controlled by a first distributed entity of the mobile network, the second edge node being controlled by a second distributed entity of the mobile network;
in response to the handover, generating a user-level report containing a portion of the diagnostic data being related to the operation of the communications link via edge nodes controlled by the first distributed entity; and
transmitting the user-level report to a centralized entity of the mobile network via the second distributed entity.

Examples described herein can be freely combined with each other if they are not mutually exclusive.

### BRIEF DESCRIPTION OF THE DRAWINGS

In the following, examples are explained in greater detail, by way of example only, making reference to the drawings in which:

FIG. 1 schematically depicts components of a computing device within a computing environment;

FIG. 2 schematically depicts entities, nodes, and devices interconnected by a mobile network; and

FIG. 3 is a flow diagram illustrating an exemplary selection of steps of managing a maintenance process in a mobile network.

### DETAILED DESCRIPTION

Past and ongoing increases in the automation of administrative operations in mobile networks, in their shift to the edge of the network and in the dependency of the associated administrative processes on data open up new possibilities for manipulation. New approaches for improving the manipulation resilience of mobile networks are therefore of interest.

A mobile network as considered herein may be structured in a hierarchical manner, with one or more centralized entities being configured for monitoring and controlling a plurality of distributed entities, the distributed entities being configured for monitoring and controlling a plurality of edge nodes, and the edge nodes being configured for providing connectivity for mobile devices (also known as user equipment, UE) to the mobile network. Some or all of the devices, nodes and entities mentioned herein may be implemented using computer systems. Open Radio Access Network (Open RAN, O-RAN) may be used herein as a primary application example, but the disclosure shall not be construed to be limited to O-RAN. Similarly, the mobile network may be configured, without limitation, for implementing one or more mobile telecommunications generation, such as 3G, 4G, 5G, and/or any further earlier, future or geographically different generations or standards.

More particularly, an edge node may be any node that is located in the mobile network between its responsible distributed entity and is configured to establish connections to mobile user devices, such as a base transceiver station (BTS), an E2 node, a Node B, an Evolved Node B (eNB), a Next Generation Node B (gNodeB, gNB), a control unit (CU), a distributed unit (DU), etc. A distributed entity may be an application-layer device such as a near-real time (near-RT) RAN Intelligent Controller (RIC) providing support and computing resources for, e.g., 3^{rd} party applications, radio connection management, mobility management, quality-of-service (QOS) management, interference management, etc. A centralized entity, such as a non-RT RIC, may assume functions of an orchestration and automation layer, including, e.g., functions related to network design, inventory, policies, configuration, monitoring and analysis, etc.

Nodes, devices, and entities of the mobile network may execute or otherwise implement automated processes, including network management processes such as the maintenance process described herein. For instance, automated processes may be specialized microservices such as rApps running on a non-RT RIC or xApps running on a near-RT RIC, and may include, without limitation, software implementing artificial-intelligence (AI) algorithms, and in particular, trained machine-learning (ML) models. Among such software, a distributed entity may operate one or more maintenance processes. A maintenance process may be any process being configured for optimizing configurations of any one or more node, device, or entity of the mobile network so as to provide an optimized QoS (e.g., maximum network availability, minimum delay times, maximum availability of resources such as bandwidth, data transfer speed, etc., maximum speech or image quality, broadest support and/or supply of software or functions, etc.) to mobile devices connected to the mobile network. In short, a maintenance process may be configured for maximizing the QoS of (provided by) one or more particular node, entity, or device of the mobile network.

The method of managing a maintenance process in a mobile network may be executed by a centralized entity and may be implemented, e.g., by software code containing computer-executable instructions, and/or at least partially in hardware logics, and may include implementations based on an artificial intelligence (AI) algorithm and/or a machine-learning (ML) model. The method includes receiving a control-level report from a first distributed entity. A control-level report may be generated repeatedly, for instance at a predefined time interval (e.g., every 2 seconds, 5 seconds, 10 seconds, 30 seconds, 1 minute, etc.), but not necessarily regularly, e.g., triggered by occurrence of a predefined event or fulfilment of a predefined condition. A control-level report may contain various information related to a status of the respective distributed entity and may include information related to operation of one or more maintenance processes deployed by the respective distributed entity. This may encompass that the control-level report may contain information related to a QoS of the respective distributed entity. For instance, a control-level report may include a time stamp indicating a time when the control-level report was created; a number of mobile devices connected to an edge node controlled by the distributed entity; a number of actions performed by one or more of the maintenance processes operated by the distributed entity; a share of a predefined usage profile in a processor load of the first distributed entity or in a network load associated with the first distributed entity; a QoS performance achieved for the predefined usage profile; a performance indicator of the maintenance process; and/or a resource usage by the maintenance process or by the first distributed entity.

The method further comprises determining a first QoS status of the first distributed entity based on the control-level report received from the first distributed entity. A QoS status may comprise a qualitative or quantitative summary or categorization of information contained in the control-level report that may measure a degree to which the first distributed entity achieves a desired optimum quality of service. For instance, a QoS status may be selected from a predefined set of categories such as “high”, “average”, and “low”; and/or may comprise a value such as a fulfilment of a service level agreement (SLA); and/or may include a trend such as “improving/increasing” or “deteriorating/decreasing”. The categories and/or trends respectively indicated by the first and second QoS status may be used as explained herein as a basis for decisions related to management of the maintenance process.

In addition, a second QoS status of the first distributed entity is determined when a user-level report is received from a mobile device that is handed over from a first edge node controlled by the first distributed entity to a second edge node controlled by a second one of the distributed entities. For this purpose, the mobile device may be configured as set forth herein to generate and transmit the user-level report in response to a handover of its registration from the first edge node to the second edge node. This, in turn, may be noticed by the mobile device from protocol information or other metadata related to its registration with the mobile network indicating that the second edge node is controlled by a different distributed entity than the first edge node. Alternatively, the second edge node or the second distributed entity may notice that the mobile device is handed over from an edge node controlled by a different distributed entity, and may request the mobile device in response to generate and transmit the user-level report. A user-level report may contain various information related to a QoS experienced by the mobile device while it was registered with one or more edge nodes controlled by the first distributed entity. For instance, a user-level report may include a time stamp indicating a time when the user-level report was created; an information identifying the mobile device such as an International Mobile Subscriber Identity (IMSI), a hardware identifier of the mobile device such as an International Mobile Station Equipment Identity (IMEI), a Media Access Control (MAC) address or an Internet Protocol (IP) address of the mobile device, etc.; and/or diagnostic data related to the communications link between the mobile device and the mobile network such as a signal quality indicator (e.g., numerical and/or categorical); a service quality indicator (e.g., numerical and/or categorical); a delay time; and protocol information exchanged between the mobile network and the mobile device for controlling the communications link.

The centralized entity may receive the user-level report from the handed-over mobile device via, e.g., the second distributed entity. A second QoS status is determined based on information contained in the user-level report. The second QoS status may be defined as explained above, and in a manner that is comparable to the first QoS status. It shall be noted that the determination of the first QoS status may be independent of the receipt of the user-level report, but may likewise be performed together with the determination of the second QoS status in response to the handover of the mobile device. Any second distributed entity that is available for receiving the mobile device's registration at one of its edge nodes from an edge node controlled by the first distributed entity may also be referred to herein as a neighbouring distributed entity of the first distributed entity.

The first and the second QoS status may each be indicative of a predefined QoS issue. A QoS issue may be defined in various ways, ranging, for instance, from simple issues such as the QoS status not being in a “Good” or otherwise acceptable category, and/or having a deteriorating trend, to more complex formulations such as specific indicator values being outside an acceptable range, and/or combinations of logical criteria based on different QoS indicators. The predefined QoS issue may generally reflect knowledge by experience about conditions of the first distributed entity being indicative of an undesirable QoS performance.

Adequate performance of the maintenance process may ensure that the first distributed entity delivers a high QoS as consistently as possible. By virtue of inverse conclusion, an undesirable QoS, as indicated by the QoS issue, may be evidence that the maintenance process is not working properly, which may be caused by activities of manipulation. As certain kinds of manipulation may also falsify the control-level report, e.g., by pretending that the first distributed entity delivers an acceptable QoS performance, the second QoS status, which is based on the user-level report and therefore cannot be controlled by potential manipulation activities on the first distributed entity, may be an independent, potentially incorruptible indicator about the real QoS performance of the first distributed entity. Thus, successful detection of a manipulation of the maintenance process may require that the second QoS status is indicative of a predefined QoS issue.

Further evidence on a potential manipulation of the maintenance process may include a (lack of) consistency of the first QoS status with the second QoS status. While the second QoS status is indicative of a QoS issue, the control-level report may be based on information that is independent of the information used for generating the user-level report. Thus, the first QoS status may independently indicate that the first distributed entity is indeed encountering a predefined QoS issue—which may in some cases be evidence that there is no manipulation of the maintenance process-but other scenarios appear possible where the first QoS status is not indicative of a QoS issue while the second QoS status is indicative of a QoS issue—which may, in some cases, substantiate the suspicion of a potential manipulation of the maintenance process. Thus, if the second QoS status is indicative of a QoS issue, the first QoS status may serve as a means for assessing whether the maintenance process is actually manipulated, and if so, for narrowing down the type of manipulation exerted on the maintenance process.

The existence and type of a potential manipulation are summarized herein as a manipulation condition of the maintenance process. For instance, as will be explained in more detail below, a possible manipulation condition may comprise an existence specification “no manipulation” with a type specification “unknown kind of underperformance”. Another exemplary manipulation condition may comprise an existence specification “manipulation” with a type specification “data poisoning” or “software malfunction”. A simple example of specifying a detection of a potential manipulation may be the case when the second QoS status is indicative of a QoS issue while the first QoS status being not indicative of a QoS issue, without any further case distinction. More complex case distinctions may be possible, as will be explained further below. A manipulation type may be identified based on characteristic features (e.g., measured performance values or values of operational parameters and/or settings of the first distributed entity) that may be included within the reported control-level or user-level information or may be known from configuration information available to the centralized entity in support of its normal orchestration and automation functions, e.g., by identifying an agreement between the currently reported information with a predefined definition of features that are characteristic for that type of manipulation.

If the manipulation condition is indicative of a potential manipulation (which corresponds to the existence specification being “manipulation” in the example above), the centralized entity triggers a cleanup routine. The cleanup routine may be implementation-specific and may be specific to the kind of manipulation that is detected (expressed by the type specification in the example above). The cleanup routine may be an automated response including a predetermined procedure to be applied in specific known types of manipulation, and/or may include outputting a notification to a human operator (e.g., an administrator or technician of the mobile network) via a user interface, a log file entry, etc. The cleanup routine does not necessarily have to be specific to an identified type of manipulation, e.g., if there is a “standard recipe” to be applied whenever a manipulation of the maintenance process is detected, regardless of the manipulation type. In any case, the cleanup routine should appear to have a deterministic effect that includes removal of the manipulation when taking into account all information about the potential manipulation that is available at the time when the cleanup routine is triggered. Possible steps that may be part of hypothetical a cleanup routine include moving existing user device connections to other edge nodes; instructing edge nodes to reconnect to other distributed entities until the manipulation condition is resolved; restarting the distributed entity and the maintenance process; purging potentially corrupt data used by the maintenance process; marking potentially corrupt data for human and/or automated analysis and/or exclusion; and/or excluding potentially corrupt data from use by the maintenance process.

Approaches described herein may yield the advantage of an improved capability for automatic detection of manipulation attempts of the manipulation process. In particular, the first QOS status, which is based on information contained in the control-level report, may be comparable to the second QoS status, which is based on different, independently collected information contained in the user-level report. For instance, without warrant of completeness, if both QoS statuses are not indicative of a QoS issue, this may be more reliable evidence that the first distributed entity is indeed performing well in terms of QoS; if both QoS statuses are indicative of a QoS issue (more particularly, the same QoS issue), this may substantiate evidence that the maintenance process is working correctly, but with reduced effectivity, or that the maintenance process, and/or the data used by the maintenance process, is manipulated without manipulation of the information included in the control-level report; if both QoS statuses are indicative of different QoS issues, this may be evidence of a manipulation of the maintenance process including information contained by the control-level report, or that the diagnostic capability of the mobile device is limited compared to that of the first distributed entity; if the second QoS status is indicative of a QoS issue but the first QoS status is not, this may indicate that the maintenance process and the control-level report are manipulated; and if the first and second QoS status are both not indicative of a QoS issue, this may substantiate evidence that there is indeed no manipulation of the maintenance process and the control-level report is as reliable as it appears.

Furthermore, approaches described herein may enable an automatic removal of manipulations of the maintenance process; an enhanced capability of diagnosing different types of manipulation; and a more specific response to different types of manipulation. For instance, the method may enable to discern between a manipulation of data consumed by the maintenance process (“data poisoning”), a manipulation of the maintenance process itself (e.g., by a virus or other malicious code), and scenarios where a manipulation seems possible at first glance, but turns out at closer inspection as an unusual performance of the first distributed entity spontaneously evolving without manipulation. In these and other cases of maintenance process manipulation in the first distributed entity, the neighbouring distributed entities may deliver authentic data about the actually experienced user-level QoS from mobile devices in handover processes. These users may provide an essentially trustworthy “testimonial” regarding the condition of the first distributed entity. In this way, approaches described herein may contribute to an increased resilience of the mobile network against data poisoning and other attacks related to proper functioning of the distributed entities.

In an example, the manipulation condition is identified as being indicative of a potential manipulation of the maintenance process affecting the control-level report if the first QoS status is not indicative of a predefined QoS issue. This may allow for identifying cases of manipulation where the user-level report is indicative of a QoS issue while the control-level report is not indicative of a QoS issue. For instance, malicious code may massage data included in the control-level report that is output by the maintenance process or otherwise deposited for inclusion in the control-level report, thus trying to conceal the manipulative activities compromising the QoS delivered by the first distributed entity. As the user-level report may have a high probability of observing the QoS actually delivered by the first distributed entity without manipulation, a control-level report lacking congruence with the user-level report may allow for detection of report-affecting manipulations with a high true-positive rate.

In an example, the identification of the manipulation condition is further based on a history dataset obtained from a knowledge base, the history dataset comprising report information being selected from the group consisting of a control-level report and a user-level report. This may facilitate assessing whether information included in a recent (user- or control-level) report is indicative of a QoS issue actually resulting from manipulation, or is rather representing a condition of undesirable QoS performance that has been observed earlier. For instance, the knowledge base may be a database local to the centralized entity, or may be stored in a distributed manner, including, e.g., a blockchain distributed over nodes of the mobile network. The history dataset may not necessarily be a record of an earlier state of the first distributed entity, as other distributed entities may have had a similar configuration and/or condition under which a particular QoS performance was observed. Thus, taking into account a history dataset may enable a more comprehensive and reliable analysis and assessment of a recent report by comparison. The history dataset may further comprise additional information such as an assessment result describing an existence specification and/or a type specification that was determined earlier for the respective distributed entity described by the report information; a QoS status determined from the report information (also referred to as the third QoS status in the following); and/or an identifier of a third QoS issue indicated by the third QoS status. In an example, a control-level report and/or a corresponding user-level report may be stored in the knowledge base only if they are not assessed of representing a potential manipulation condition of the maintenance process. In an example, a control-level report and/or a corresponding user-level report representing a potential manipulation condition of the maintenance process may be stored in the knowledge base with an identifier indicating the found existence and/or type of manipulation represented by the respective report information.

In an example, the identification of the manipulation condition is based on the history dataset if the first QoS status is indicative of a predefined QoS issue. This may facilitate identifying the existence and/or assessing the type of a potential manipulation when the user-level report and the control-level report are both indicative of a QoS issue. For instance, there may be attack scenarios where malicious code leads to a QoS deterioration of the first distributed entity that is detectable both in the control-level report and the user-level report, or where manipulated (“poisoned”) data leads to inappropriate functioning of the maintenance process, thus causing the observed QoS deterioration. These may be part of a class of scenarios where comparison of the currently reported information (e.g., the information included in the control-level report and/or in the user-level report) with information that was reported earlier (i.e., the information included in the history dataset) may yield a basis for assessing whether the presently observed status of the first distributed entity is a sign of manipulation, or rather, of a known condition of QoS underperformance that has been observed within the mobile network before. The detection of a manipulation by comparison may also enable an assessment of a manipulation type by identifying common features of information included within the history dataset and the currently reported information and/or identifying an agreement between the currently reported information with a predefined definition of features that are characteristic for that type of manipulation.

In an example, the maintenance process is part of a first setup of maintenance processes operated by the first distributed entity, the identification of the manipulation condition further comprising, if the first QOS status is indicative of a predefined QoS issue, searching a reference dataset in the knowledge base, the search comprising selecting a history dataset from the knowledge base as the reference dataset if the report information of the history dataset is descriptive of a similar distributed entity having a second setup of maintenance processes fulfilling a predefined first similarity criterion with respect to the first setup, and if the report information of the history dataset is indicative of a third QoS status of the similar distributed entity fulfilling a predefined second similarity criterion with respect to the first QoS status, the cleanup routine being further configured for removing the manipulation based on a result of the search. This may allow for determining the existence and/or the type of manipulation with a higher significance. The search may be selective to find history datasets whose report information is indicative of a similar QoS status that was observed while deploying a similar setup of maintenance processes.

While a history dataset may contain an existence specification and/or a type specification regarding a potential (non-) detection of a manipulation, the mere existence of a history dataset that is eligible as a reference dataset may already be significant for assessing the existence and type of a present manipulation without such information, as explained in the following. The first similarity criterion may concern the identity of maintenance processes running on the distributed entity described by the respective history dataset. For instance, a first similarity criterion may require that the second setup is identical to the first setup, or differs from the first setup in a specified manner, e.g., by not more than one, two, . . . deployed maintenance processes. In that regard, it may be reasonable to require that the maintenance process (i.e., the maintenance process under suspicion of manipulation) shall be present both in the first setup and the second setup. The second similarity criterion may concern the third QoS status of the respective distributed entity indicated by the report information contained in the history dataset. The third QoS status may have been determined at an earlier time and may thus be included in the history dataset; alternatively, the third QoS status may be determined as part of the search if it is not protocolled within the history dataset. For instance, the second similarity criterion may require that the third QoS status is identical to the first QoS status, or differs from the first QoS status in a specified manner, e.g., by not more than a certain percentage delta, by requiring a same QoS status category but not necessarily a same QoS status trend, etc. User-level reports present in the knowledge base may be used in addition to verify the actual QoS status of the respective distributed entity reported by a specific control-level report stored in the knowledge base, or to identify similar past scenarios where the reported user-level and control-level QoS statuses from the knowledge base behave in a same or similar manner as the present user-level and control-level QoS statuses that triggered the search.

The cleanup routine may depend on a result of the search. For instance, if no reference dataset is found, this may be interpreted as a detection of a manipulation, triggering, e.g., a universal (type-independent) cleanup routine; if a reference dataset is found and specifies, or is indicative of, a particular manipulation type, then a type of cleanup routine may be chosen specific to the identified manipulation type; or the process implementing the method may deploy further analysis steps to identify more distinguished types of manipulation, based on whether a reference dataset has been found or not.

In an example, the manipulation condition is identified as being indicative of a potential manipulation of the maintenance process based on data poisoning if the search does not result in a selection of a history dataset from the knowledge base as the reference dataset. This may enable a detection of data poisoning attacks on the maintenance process with a high significance, and may allow for triggering the cleanup routine to implement a response specific to this type of attack. Data poisoning is understood herein as any change, addition, replacement, or deletion of data that the maintenance process would normally use as input for its intended function in support of maximizing the QoS of the first distributed entity. Hence, if the second QoS status is indicative of a predefined QoS issue and the knowledge base does not contain a history dataset evidencing an earlier observation of a similar condition of the a distributed entity, this may be a hint that the current QoS performance of the first distributed entity is atypical for a non-manipulated operation, and thus, that a potential manipulation of the maintenance process is detected. This may be true with even higher significance if the first and the second QoS status are both indicative of a predefined QoS issue, as the potential manipulation may then be of a type that does not affect the control-level report, and may thus be of a data-poisoning type.

In an example, the identification of the manipulation condition further comprises, if the search results in a selection of a history dataset from the knowledge base as the reference dataset, reading a first activity parameter of the maintenance process operated by the first distributed entity from the control-level report, reading a second activity parameter of the maintenance process operated by the similar distributed entity from the reference dataset, and comparing the first activity parameter with the second activity parameter, the cleanup routine being further based on a result of the comparison. This may allow for detecting an unusual behaviour of the maintenance process even if a reference dataset is found documenting a similar status of the similar distributed entity. In this manner, more “well-hidden” types of manipulation may be detected that cause a QoS issue which at first glance does not appear unusual as similar conditions have been observed in the mobile network before. An activity parameter may be any parameter related to a performance of the maintenance process (or respectively, the instance of the maintenance process that was executed by the similar distributed entity), such as a resource consumption of the maintenance process (e.g., CPU percentage, memory occupancy, network load, etc.), a number of actions performed by the maintenance process within a predefined time interval, a number of threads started by the maintenance process, a performance-related quantity derived from an output of the maintenance process, etc., without limitation to the foregoing. The cleanup routine may be selected specific to a result of the comparison, such as doing nothing if the first and second activity parameters fulfil a predefined similarity criterion; performing cleanup actions if the compared activity parameters deviate from each other significantly; or selecting a specific type of cleanup routine depending on a degree of similarity or difference between the first and second activity parameter.

In an example, the manipulation condition is identified as being indicative of a potential operational manipulation of the maintenance process if the comparison is indicative of a difference between the first activity parameter and the second activity parameter fulfilling a predefined significance criterion. This may allow for detecting an operational manipulation of the maintenance process (such as a virus or other malware affecting correct functioning of the maintenance process even if the data processed by the maintenance process is not corrupt) with a high significance. For instance, it may be assumed that a similar QoS status achieved by a distributed entity (the similar distributed entity) under similar operating conditions (corresponding to fulfilment of the first and second similarity criteria) should be also reflected by a similar performance (measured by the first activity parameter) of the maintenance process being executed by the first distributed entity as it is documented by the second activity parameter from the reference dataset. Such similarity of performance may be specified using the predefined significance criterion, which may require, for instance, that the first activity parameter should not deviate from the second activity parameter by more than a predefined (absolute or relative) amount to be interpreted as being similar to the second activity parameter. The significance criterion may specify further logics such as counting only a positive (only negative) difference from the second activity parameter as a significant deviation, etc. If the observed difference is significant, the performance of the maintenance process may be interpreted as being unusual, and thus, as evidence of an operational manipulation of the maintenance process as a detection of data poisoning (see discussion above) may be unlikely.

In an example, the manipulation condition is identified as being not indicative of a potential manipulation of the maintenance process if the comparison is not indicative of a difference between the first activity parameter and the second activity parameter fulfilling a predefined significance criterion. This may allow for exiting the manipulation analysis if no evidence for a manipulation of the maintenance process (e.g., due to neither data poisoning nor operational manipulation) is found. For instance, it may be assumed that a similar QoS status achieved by a distributed entity (the similar distributed entity) under similar operating conditions (corresponding to fulfilment of the first and second similarity criteria) should be also reflected by a similar performance (measured by the first activity parameter) of the maintenance process being executed by the first distributed entity as it is documented by the second activity parameter from the reference dataset. Such similarity of performance may be specified using the predefined significance criterion, which may require, for instance, that the first activity parameter should not deviate from the second activity parameter by more than a predefined (absolute or relative) amount to be interpreted as being similar to the second activity parameter. The significance criterion may specify further logics such as counting only a positive (only negative) difference from the second activity parameter as a significant deviation, etc. If the observed difference is not significant, the performance of the maintenance process may be interpreted as being normal, and thus, as a lack of evidence of an manipulation of the maintenance process as a detection of data poisoning and of operational manipulation (see the respective explanations above) may both be unlikely.

In an example, the method further comprises storing the user-level report and the control-level report in the knowledge base if the manipulation condition does not indicate a potential manipulation of the maintenance process. This may contribute to keeping the knowledge base clean from history datasets that represent distributed entities with an ongoing manipulation of one or more of their respectively running maintenance processes. This may ensure that each history dataset (including each reference dataset) to which the current control-level report and/or user-level report is compared represents operational conditions of a distributed entity that are not confounded by effects of manipulated maintenance processes, and may thus facilitate identifying a manipulation of the current instance of the maintenance process with a high significance. In particular, the user-level report and/or the control-level report may be stored in the knowledge base only if the manipulation condition does not indicate a potential manipulation of the maintenance process.

In an example, the cleanup routine comprises restarting the first distributed entity. This may enable an effective removal of the potential manipulation of the maintenance process. In particular, restarting the first distributed entity may quit the execution of all process running on the first distributed entity, including the maintenance process (in the following referred to as the first instance of the maintenance process), and starting a new second instance of the maintenance process after reboot of the first distributed entity. The second instance may be initialized with no regard to any input data that was used as an input to the first instance. More particularly, restarting the first distributed entity may include a deletion of the input data of the first instance, including any possible portion of poisoned data. Moreover, the second instance of the maintenance process may be loaded from a file system image representing a clean, manipulation-free setup of the first distributed entity. This may enable a removal of any potential viruses or other types of malicious software that may have affected the first instance independent of a potential manipulation of its input data. A cleanup routine comprising restarting the first distributed entity may further comprise handing over the control over the first edge node(s) to one or more neighbouring distributed entities before the restart, and handing over the control over the first edge node(s) back to the first distributed entity after the restart to ensure a continuous and issue-free operation of the edge nodes during the restart. The restart of the first distributed entity may be triggered by a command or message sent by the centralized entity to the first distributed entity.

In an example, the first distributed entity is configured for collecting diagnostic data associated with operation of the first distributed entity in a first repository and for performing the operation of the maintenance process based on the diagnostic data, the cleanup routine comprising configuring the first distributed entity for diverting the collection of diagnostic data to a second repository not associated with the first distributed entity and for continuing the operation of the maintenance process based on only the diagnostic data collected in the second repository. This may yield a protection from data poisoning occurring at the first repository as a simultaneous manipulation of input data to the maintenance process at the second repository may be unlikely. Moreover, diverting the collection of the diagnostic data may facilitate determining whether the observed QoS issue is actually caused by data poisoning or not. If the QoS issue is not resolved in response to the diversion, data poisoning at the first repository may be unlikely, and thus, the collection of diagnostic data may be diverted back to the first repository if no evidence of other types of manipulation is found. Diverting the collection of diagnostic data from the first to the second repository may include that no diagnostic data shall be copied from the first repository to the second repository (to avoid a potential spillover of corrupt diagnostic data to the second repository), but diverting the collection of diagnostic data from the second to repository back to the first repository may include that the diagnostic data collected for the first distributed entity in the second repository is moved or copied from the second repository to the first repository.

The first repository may be a data storage unit such as a portion of memory or other storage facility, including a database, operated by or attached to the first distributed entity and/or operated remotely and provided to the first distributed entity via the mobile network. Likewise, the second repository may be a data storage unit such as a portion of memory or other storage facility, including a database, operated by or attached to a different distributed entity and/or operated remotely and provided to the different distributed entity via the mobile network. Requiring that the second repository be not associated with the first distributed entity may include that the second repository shall be operated by a computer system that, in terms of hardware, is different from the computer system operating the first repository, which may include that the different computer system is located at a location that is geographically separated from the location of the computer system operating the first repository.

In an example, the control-level report comprises first diagnostic data being related to operation of the first distributed entity, being representative of a predefined reporting time interval and being selected from the group consisting of a number of mobile devices registered with edge nodes controlled by the first distributed entity; a number of actions performed by the maintenance process; a share of a predefined usage profile in a processor load of the first distributed entity or in a network load associated with the first distributed entity; a QoS performance achieved for the predefined usage profile; a performance indicator of the maintenance process; and a resource usage by the maintenance process or by the first distributed entity. These types of information may facilitate and contribute to an identification of a QoS issue and/or a manipulation of the maintenance process with a high significance. The reporting time interval may be implementation-specific, such as a constant reporting time interval for regular report submissions, the time measured between two event-triggered report submissions, etc.

For instance, performance figures of the maintenance process or of the first distributed entity in total may scale with the number of registered mobile devices, such that an assessment whether an observed scale of activity is unusual may take this number into account by, e.g., determining an amount of activity per registered mobile device.

For instance, a share of a predefined usage profile in a processor load of the first distributed entity or a network load associated with the first distributed entity may alternatively or additionally be useful to assess the QoS delivered by the first distributed entity, which may be a hint on an effectiveness of the maintenance process, wherein a predefined usage profile may be understood as a category that is assigned to a portion (e.g., a thread to be processed by a processor of the first distributed entity, or data to be processed by a processor or to be transferred via a link of the mobile network) of processor load (e.g., a number or percentage of cycles within a predefined time interval) or network load (e.g., an amount or percentage of network bandwidth) and reflects technical requirements or properties that are related to the connections between mobile devices and the mobile network and are characteristic of the processor load or network load. Without limitation, a 5G mobile network may typically have defined usage profiles “Enhanced Mobile Broadband” (eMBB), “Ultra-Reliable Low-Latency Communication” (uRLLC), and “Massive Machine-Type Communication” (mMTC), whereas similar usage profiles may be defined in an analogous manner for different mobile network generations or types.

For instance, a QoS performance achieved for a specific usage profile may allow for assessing the QoS delivered by the first distributed entity more directly, e.g., by comparison of the QoS performance with criteria representing limits of parameter ranges corresponding to different QoS status categories. A QoS performance may be expressed in one or more QoS-related quantities, such as a number of mobile devices for which respective parameter intervals representing requirements of a respective service level agreement (SLA) was achieved or was not achieved, or other quantities that may be assessed independent of SLA requirements such as a provided bandwidth, signal strength, etc.

For instance, a performance indicator of the maintenance process may facilitate determining an activity level of the maintenance process and whether the activity of the maintenance process is unusual or not. A performance indicator may be defined as a quantity related to operation of the maintenance process and its environment provided by the first distributed entity, such as a number of actions (e.g., outputs, data operations, threads, context switches, etc.) of the maintenance process, a quantity related to hardware of or a resource provided by the first distributed entity (e.g., a processor load, a network load, a memory occupancy, . . . of the maintenance process) or another resource of the mobile network, an amount of output generated by the maintenance process (e.g., an amount of data or a number of output events), etc.

For instance, a resource usage by the maintenance process or by the first distributed entity may enable an assessment whether the maintenance process or the first distributed entity exhibit an unusual performance or not, including but not limited to resources provided by the first distributed entity, such as a quantity related to hardware of or a resource provided by the first distributed entity (e.g., a processor load, a network load, a memory occupancy, . . . of the maintenance process) or consumed by the first distributed entity (e.g., an amount of allocated memory, database storage capacity, network bandwidth, computing resources external to the first distributed entity), etc.

In an example, the user-level report comprises second diagnostic data being related to a communications link of the mobile device to the mobile network via edge nodes controlled by the first distributed entity, the second diagnostic data being selected from the group consisting of a signal quality indicator; a service quality indicator; a delay time; and protocol information exchanged between the mobile network and the mobile device for controlling the communications link. These types of information may facilitate and contribute to an identification of a QoS issue and/or a manipulation of the maintenance process with a high significance. For instance, a signal quality indicator (e.g., a signal-to-noise ratio or other signal strength), a delay time (e.g., one half of a response time via the communications link) or other service quality indicator (e.g., a bandwidth of data transmission between the mobile network and the mobile device) may enable an accurate assessment of the service quality provided by the first distributed entity by comparison to predefined nominal standard values and ranges, or to requirements such as a degree of fulfilment of a service level agreement (SLA) for the mobile device. Protocol information exchanged between the mobile network and the mobile device for controlling the communications link (e.g., a used frequency band, parameters related to modulation, encryption, etc.) may provide additional information about parameters of the communications link to which the assessment of service quality may be quantitatively or logically related.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 150 implementing the method of managing a maintenance process in a mobile network. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

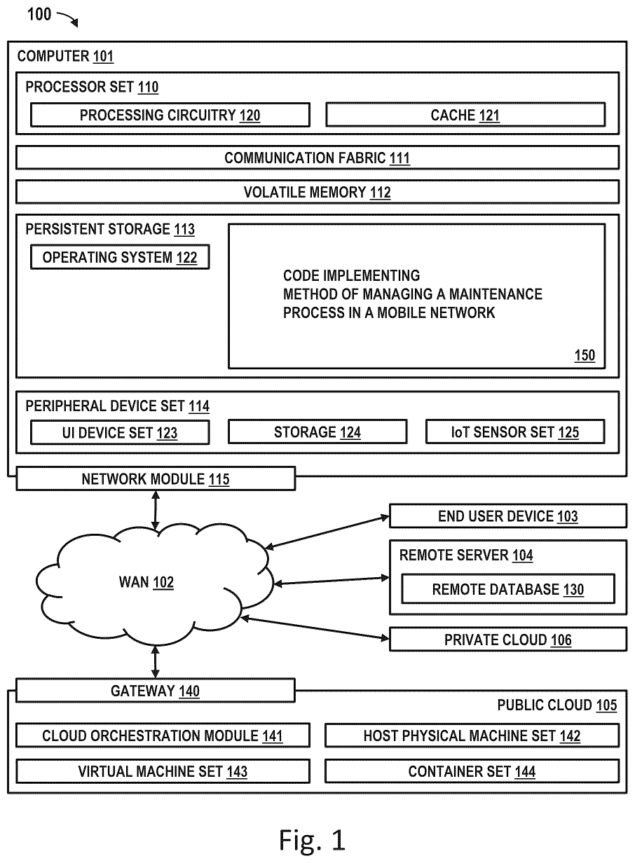

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

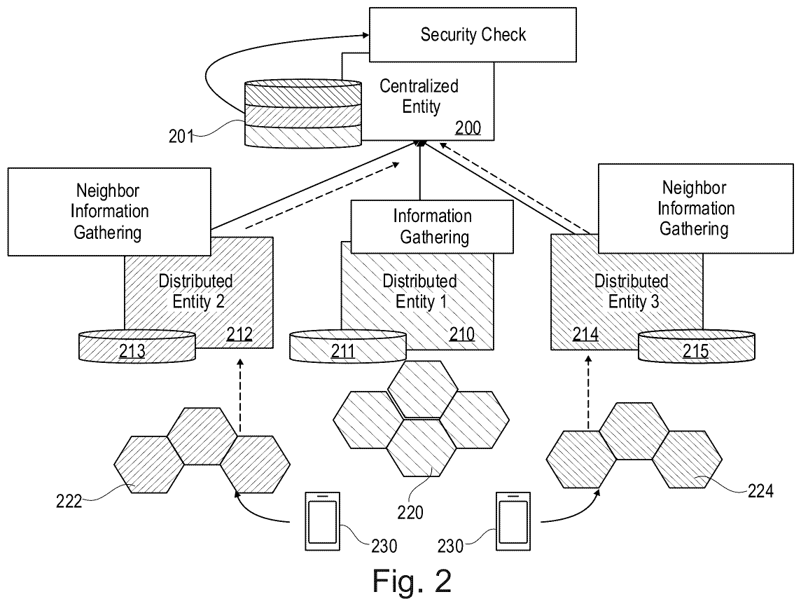

FIG. 2 schematically depicts entities, nodes, and devices interconnected by a mobile network. The connections are schematically illustrated by arrows in the drawing. The mobile network may comprise a centralized entity 200 that is configured for controlling multiple distributed entities 210, 212, 214. The mobile network may further comprise edge nodes 220, 222, 224, wherein a first distributed entity 210 may be configured for controlling a plurality of first edge nodes 220, a second distributed entity 212 may be configured for controlling a plurality of second edge nodes 222, and a third distributed entity 214 may be configured for controlling a plurality of third edge nodes 224. The second distributed entity 212 and the third distributed entity 214 may also be referred to as neighbours, or neighbouring distributed entities, of the first distributed entity 210 if no further distributed entity is geographically interposed between the respective distributed entity 212, 214 and the first distributed entity 210. Mobile devices 230 may be connected to the mobile network via respective communications links to respective ones of the edge nodes 220, 222, 224. The first distributed entity 210 may operate, or have associated, a first storage repository 211; the second distributed entity 212 may operate, or have associated, a second storage repository 213; the third distributed entity 214 may operate, or have associated, a third storage repository 215; and the centralized entity 200 may operate, or have associated, a central storage repository 201.

The centralized entity 200 may store and execute code implementing the method of managing a maintenance process in a mobile network described herein. In response to executing said code, the centralized entity 200 may receive a control-level report from the first distributed entity 210 (and likewise, also from the second distributed entity 212 and the third distributed entity 214, which, however, may be irrelevant in the following description, such that any reference to “the control-level report” may refer to the control-level report the centralized entity 200 receives from the first distributed entity 210). The transmission of the respective control-level reports is symbolized in the drawing by a solid arrow pointing from the respective distributed entity 210, 212, 214 to the centralized entity 200. The centralized entity 200 may store the received control-level reports in the central repository 201 for further processing and analysis. The control-level report may contain first diagnostic data that was collected during operation of the first distributed entity 210 within a predefined reporting time interval. Portions of the information contained in the control-level report may be related to a quality of service, QoS, of the first distributed entity 210.

The first distributed entity 210 may store and execute code implementing a maintenance process that is configured for contributing to a maximization of the QoS of the first distributed entity 210. In an example of a 5G implementation, the maintenance process may be an xApp running on a near-RT RIC implementing the first distributed entity, and may include, without limitation, software implementing deterministic and/or probabilistic algorithms, including but not limited to computer programs implemented following a procedural, object-oriented, . . . paradigm and/or artificial-intelligence (AI) algorithms, and in particular, trained machine-learning (ML) models. The maintenance process may be any process being configured for optimizing a configuration of the first distributed entity 210 so as to provide an optimized QoS (e.g., maximum network availability, minimum delay times, maximum availability of resources such as bandwidth, data transfer speed, etc., maximum speech or image quality, broadest support and/or supply of software or functions, etc.) to mobile devices 230 connected to the mobile network. In short, the maintenance process may be configured for maximizing the QoS of (provided by) the first distributed entity 210.

The centralized entity 200 may analyse the information contained by the control-level report to determine a first QoS status of the first distributed entity 210. The first QoS status, and the second QoS status mentioned below analogously, may comprise a qualitative or quantitative summary or categorization of information contained in the control-level report that may measure a degree to which the first distributed entity 210 achieves a desired optimum quality of service. For instance, a QoS status may be selected from a predefined set of categories such as “high”, “average”, and “low”; and/or may comprise a value such as a fulfilment of a service level agreement (SLA); and/or may include a trend such as “improving/increasing” or “deteriorating/decreasing”, without limitation.

An exemplary mobile device 230 may, e.g., change its geographical position while maintaining a communications link to one of the first edge nodes 211. In response thereto, the communications link, and thus, the registration of the mobile device 230 with the mobile network, may be handed over to a second edge node 213 or, depending on the direction of geographical relocation, to a third edge node 215. For simplicity of presentation, it is assumed in the following that the mobile device 230 is handed over to a second edge node 213 controlled by the second distributed entity 212.

The mobile device 230 may store and execute code implementing the method of operating a mobile communications device described herein. In response to the execution of said code, the mobile device 230 may collect information related to the communications link, in particular related to a QoS observed for the communications link, while the first edge node 22 is the opposite party of the communications link. In response to the aforementioned handover (e.g., by actively noticing completion of the handover, or in response to receiving a corresponding notification from the second edge node 213), the mobile device 230 may compile a user-level report containing portions of the collected information. For instance, the user-level report may include a time stamp indicating a time when the user-level report was created; an information identifying the mobile device 230 such as an International Mobile Subscriber Identity (IMSI), a hardware identifier of the mobile device 230 such as an International Mobile Station Equipment Identity (IMEI), a Media Access Control (MAC) address or an Internet Protocol (IP) address of the mobile device, etc.; and/or diagnostic data related to the communications link between the mobile device 230 and the mobile network such as a signal quality indicator (e.g., numerical and/or categorical); a service quality indicator (e.g., numerical and/or categorical); a delay time; and protocol information exchanged between the mobile network and the mobile device 230 for controlling the communications link. The mobile device 230 may transmit the user-level report to the centralized entity 200, for instance via the second edge node 213 holding the communications link after the handover and via the second distributed entity 212. In the drawing, the transmission is indicated by dashed arrows.

The centralized entity 200 may receive the user-level report and, as the information included therein is related to the first distributed entity 210, may determine a second QoS status of the first distributed entity 210 based on the user-level report. The centralized entity 200 may have available definition(s) of one or more QoS issues as which a QoS status may be interpreted. A QoS issue may be defined in various ways, ranging, for instance, from simple issues such as the QoS status not being in a “Good” or otherwise acceptable category, and/or having a deteriorating trend, to more complex formulations such as specific indicator values being outside an acceptable range, and/or combinations of logical criteria based on different QoS indicators. The predefined QoS issue may generally reflect knowledge by experience about conditions of the first distributed entity 210 being indicative of an undesirable QoS performance. The centralized entity 200 may apply said definition(s) to at least the second QoS status to determine whether the second QoS status is indicative of a QoS issue of the first distributed entity 210.

If the second QoS status is indicative of a QoS issue, the centralized entity 200 may proceed with identifying a manipulation condition of the maintenance process, based at least on the first QoS status in addition or comparison to the second QoS status. For instance, a possible manipulation condition may comprise an existence specification “no manipulation” with a type specification “unknown kind of underperformance”. Another exemplary manipulation condition may comprise an existence specification “manipulation” with a type specification “data poisoning” or “software malfunction”. A simple example of specifying a detection of a potential manipulation may be the case when the second QoS status is indicative of a QoS issue while the first QoS status being not indicative of a QoS issue, without any further case distinction. More complex case distinctions may be possible, as explained herein in more detail. A manipulation type may be identified based on characteristic features (e.g., measured performance values or values of operational parameters and/or settings of the first distributed entity 210) that may be included within the reported control-level or user-level information or may be known from configuration information available to the centralized entity 200 in support of its normal orchestration and automation functions, e.g., by identifying an agreement between the currently reported information with a predefined definition of features that are characteristic for that type of manipulation.

If the manipulation condition is indicative of a potential manipulation of the maintenance process, the centralized entity 200 may invoke a cleanup routine to be executed by the centralized entity 200, the first distributed entity 210 and/or another node, device, or entity of the mobile network that is configured to control operations of the first distributed entity 210 and/or edges, devices or nodes of the mobile network controlled by or associated with the first distributed entity 210, such as the first edge nodes 220 and/or the first repository 211. The cleanup routine may be configured to effect a removal of the identified potential manipulation as can be expected based on the information the centralized entity 200 has collected about the potential manipulation at the time of triggering the cleanup routine, including but not limited to the manipulation condition.

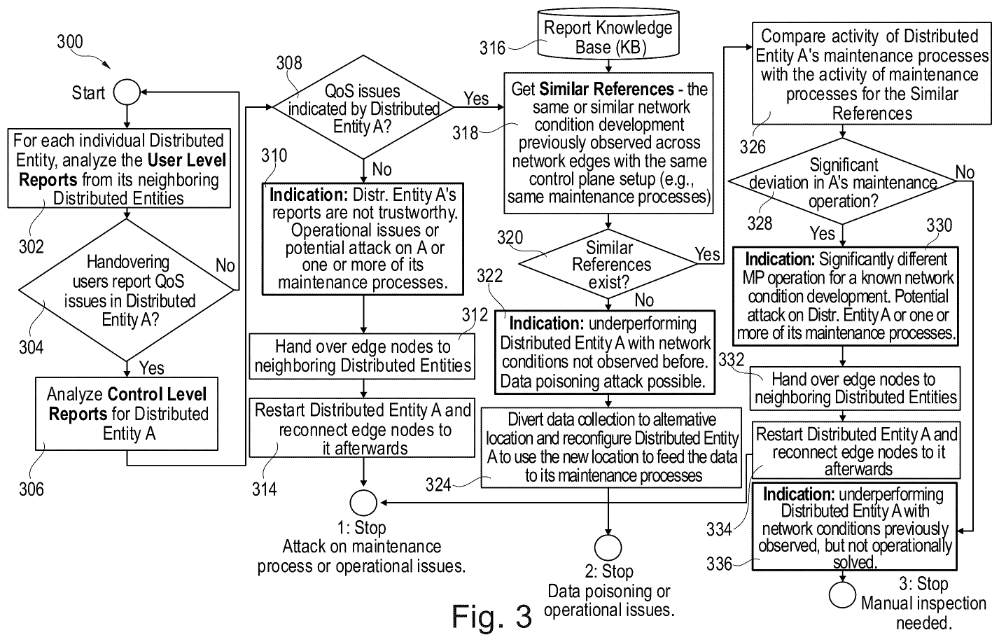

FIG. 3 is a flow diagram illustrating a procedure 300 containing an exemplary selection of steps of managing a maintenance process in a mobile network. It shall be understood that neither the selection of said steps, nor the logical interconnections between them, may be construed as limitations of the methods, concepts and approaches described herein, but have been chosen for the sole purpose of illustrating said methods, concepts and approaches using procedure 300 as a practical example. Procedure 300 may be implemented, e.g., by the centralized entity 200.

The procedure 300 may start with analysing 302, for each individual distributed entity 210, the user-level reports received from mobile devices 230 having been handed over from edge nodes 220 controlled by the respective distributed entity 210 to be assessed by said analysis 302 of the user-level reports (in the following referred to as Distributed Entity A) to edge nodes 222, 224 controlled by any distributed entities 212, 214 neighbouring Distributed Entity A 210.

Procedure 300 may continue by determining 304 whether one or more of the received user-level reports is indicative of a QoS issue of Distributed Entity A 210. If this is not the case, the procedure may return to the start, thus continuing the monitoring of the distributed entities 210, 212, 214. If there is a user-level report indicating a QoS issue of Distributed Entity A 210, the procedure 300 may continue by analysing 306 one or more control-level reports received from the Distributed Entity A 210 to determine 308 whether there is a control-level report that is also indicating a QoS issue of Distributed Entity A 210.

If the analysed control-level reports are not indicative of a QoS issue, the procedure 300 may branch 310 into a first sub-procedure for handling a potential manipulation of the maintenance process by an attack on a functionality of the maintenance process. While it may be possible that operational issues of Distributed Entity A 210 causing the observed QoS issue instead of a manipulation cannot be excluded, it may be worthwhile to start 310 the first sub-procedure anyway for reasons of security and efficiency, as there may be a possibility that control-level reports received from Distributed Entity A 210 are not trustworthy. The first sub-procedure may include handing over 312 edge nodes 220 to neighbouring distributed entities 212, 214, restarting 314 Distributed Entity A 210, and reconnecting the edge nodes 220 to Distributed Entity A 210 after the restart 314. The first sub-procedure may be finished at this point, allowing the procedure 300 to return to the beginning as described above.

If one or more of the control-level reports are indicative of a QoS issue, the procedure 300 may continue by reading 318 history datasets from a knowledge base 316 that may contain user-level reports and/or control-level reports documenting QoS conditions that have been observed earlier in the mobile network. The history datasets may be analysed to determine 320 whether among the history datasets there is a reference dataset documenting a same or similar status or development of network conditions in relation to any distributed entity of the mobile network having a same or similar control-plane setup, including a same or similar setup of maintenance processes configured for maximizing a QoS of the respective distributed entity hosting said maintenance processes.

If no such reference dataset is found, procedure 300 may branch 322 into a second sub-procedure specific to the presumed condition that Distributed Entity A 210 is underperforming with respect to QoS, having network conditions that have not been observed before and which may thus be interpreted as a manipulation of the maintenance process by a data poisoning attack. The second sub-procedure may include diverting 324 the collection of data by the Distributed Entity A 210 to be used as input data by the maintenance process to a future collection of such data, still related to Distributed Entity A 210, at other distributed entities such as its neighbouring distributed entities 212, 214 (more specifically, at their respective repositories 213, 215); and accordingly reconfiguring the Distributed Entity A 210 to use the new location(s) to feed the data its the maintenance processes. The second sub-procedure may be finished at this point, allowing the procedure 300 to return to the beginning as described above.

If a reference dataset is found within the knowledge base 316, procedure 300 may continue by comparing 326 an activity of the maintenance process with the corresponding activity of the same maintenance process at the similar distributed entity documented by the reference dataset to assess 328 whether the activity of the current maintenance process operated by Distributed Entity A 210 deviates significantly from the corresponding activity at the similar distributed entity. If the compared activity shows no significant difference between the two activities, the procedure 300 may finish 336 at this point as the Distributed Entity A 210 may be underperforming with network conditions that have been observed before, but not operationally solved yet. In this case, procedure 300 may return to the beginning as described above, and may optionally generate (e.g., storing, depositing, or displaying) a message for a human operator of the mobile network for future resolution of the causes underlying the unresolved QoS issue.

If there is a significant deviation between the observed activities, procedure 300 may continue by branching 330 into a third sub-procedure specific to the presumed condition that the observed significant operational deviation of maintenance processes for a known status or development of network conditions is evidence for a potential attack on the maintenance process operated by Distributed Entity A 210. In the example or FIG. 3, the third sub-procedure may handle this situation in an analogous manner as the first sub-procedure, by handing over 332 the first edge nodes 220 to other (e.g., neighbouring) distributed entities, and restarting 334 Distributed Entity A 210 and reconnecting edge nodes 220 to Distributed Entity A 210. The third sub-procedure may be finished at this point, allowing the procedure 300 to return to the beginning as described above.

In the following, examples illustrating notions described herein will be described again by a list of clauses highlighting several possible, non-exclusive combinations of features described herein:
1. A computer-implemented method of managing a maintenance process in a mobile network, the mobile network comprising a centralized entity and distributed entities, the distributed entities controlling edge nodes configured for registering mobile devices with the mobile network, the method comprising, by the centralized entity:
   receiving from a first one of the distributed entities a control-level report related to a quality of service, QoS, of the first distributed entity, the first distributed entity being configured for maximizing the QoS of the first distributed entity by operating the maintenance process;
   based on the control-level report, determining a first QoS status of the first distributed entity;
   in response to registration of a mobile device being handed over from a first edge node controlled by the first distributed entity to a second edge node controlled by a second one of the distributed entities:
      based on a user-level report related to the QoS of the first distributed entity and received from the mobile device, determining a second QoS status of the first distributed entity;
      if the second QoS status is indicative of a predefined QoS issue, identifying a manipulation condition of the maintenance process based on the first QoS status, and if the manipulation condition indicates a potential manipulation of the maintenance process, triggering a cleanup routine configured for removing the potential manipulation based on the manipulation condition.
2. The method of clause 1, the manipulation condition being identified as being indicative of a potential manipulation of the maintenance process affecting the control-level report if the first QoS status is not indicative of a predefined QoS issue.
3. The method of clause 1 or 2, the identification of the manipulation condition being further based on a history dataset obtained from a knowledge base, the history dataset comprising report information being selected from the group consisting of a control-level report and a user-level report.
4. The method of clause 3, the identification of the manipulation condition being based on the history dataset if the first QoS status is indicative of a predefined QoS issue.
5. The method of clause 3 or 4, the maintenance process being part of a first setup of maintenance processes operated by the first distributed entity, the identification of the manipulation condition further comprising, if the first QoS status is indicative of a predefined QoS issue, searching a reference dataset in the knowledge base, the search comprising selecting a history dataset from the knowledge base as the reference dataset if the report information of the history dataset is descriptive of a similar distributed entity having a second setup of maintenance processes fulfilling a predefined first similarity criterion with respect to the first setup, and if the report information of the history dataset is indicative of a third QoS status of the similar distributed entity fulfilling a predefined second similarity criterion with respect to the first QoS status, the cleanup routine being further configured for removing the manipulation based on a result of the search.
6. The method of clause 5, the manipulation condition being identified as being indicative of a potential manipulation of the maintenance process based on data poisoning if the search does not result in a selection of a history dataset from the knowledge base as the reference dataset.
7. The method of clause 5 or 6, the identification of the manipulation condition further comprising, if the search results in a selection of a history dataset from the knowledge base as the reference dataset, reading a first activity parameter of the maintenance process operated by the first distributed entity from the control-level report, reading a second activity parameter of the maintenance process operated by the similar distributed entity from the reference dataset, and comparing the first activity parameter with the second activity parameter, the cleanup routine being further based on a result of the comparison.
8. The method of clause 7, the manipulation condition being identified as being indicative of a potential operational manipulation of the maintenance process if the comparison is indicative of a difference between the first activity parameter and the second activity parameter fulfilling a predefined significance criterion.
9. The method of clause 7 or 8, the manipulation condition being identified as being not indicative of a potential manipulation of the maintenance process if the comparison is not indicative of a difference between the first activity parameter and the second activity parameter fulfilling a predefined significance criterion.
10. The method of any of clauses 3 to 9, further comprising storing the user-level report and the control-level report in the knowledge base if the manipulation condition does not indicate a potential manipulation of the maintenance process.
11. The method of any of the preceding clauses, the cleanup routine comprising restarting the first distributed entity.
12. The method of any of the preceding clauses, the first distributed entity being configured for collecting diagnostic data associated with operation of the first distributed entity in a first repository and for performing the operation of the maintenance process based on the diagnostic data, the cleanup routine comprising configuring the first distributed entity for diverting the collection of diagnostic data to a second repository not associated with the first distributed entity and for continuing the operation of the maintenance process based on only the diagnostic data collected in the second repository.
13. The method of any of the preceding clauses, the control-level report comprising first diagnostic data being related to operation of the first distributed entity, being representative of a predefined reporting time interval and being selected from the group consisting of a number of mobile devices registered with edge nodes controlled by the first distributed entity; a number of actions performed by the maintenance process; a share of a predefined usage profile in a processor load of the first distributed entity or in a network load associated with the first distributed entity; a QoS performance achieved for the predefined usage profile; a performance indicator of the maintenance process; and a resource usage by the maintenance process or by the first distributed entity.
14. The method of any of the preceding clauses, the user-level report comprising second diagnostic data being related to a communications link of the mobile device to the mobile network via edge nodes controlled by the first distributed entity, the second diagnostic data being selected from the group consisting of a signal quality indicator; a service quality indicator; a delay time; and protocol information exchanged between the mobile network and the mobile device for controlling the communications link.
15. A computer program product for managing a maintenance process in a mobile network, the mobile network comprising a centralized entity and distributed entities, the distributed entities controlling edge nodes configured for registering mobile devices with the mobile network, the computer program product comprising a computer readable storage medium having program instructions embodied therewith, the program instructions being executable by the centralized entity to cause the centralized entity to perform a method comprising:
   receiving from a first one of the distributed entities a control-level report related to a quality of service, QoS, of the first distributed entity, the first distributed entity operating the maintenance process;
   based on the control-level report, determining a first QoS status of the first distributed entity;
   in response to registration of a mobile device being handed over from a first edge node controlled by the first distributed entity to a second edge node controlled by a second one of the distributed entities:
      based on a user-level report related to the QoS of the first distributed entity and received from the mobile device, determining a second QoS status of the first distributed entity;
      if the second QoS status is indicative of a predefined QoS issue, identifying a manipulation condition of the maintenance process based on the first QoS status, and if the manipulation condition indicates a potential manipulation of the maintenance process, triggering a cleanup routine configured for removing the potential manipulation based on the manipulation condition.
16. A computing device being configured as a centralized entity of a mobile network, the mobile network further comprising distributed entities controlling edge nodes of the mobile network, the edge nodes being configured for registering mobile devices with the mobile network, the computing device comprising a processor and a memory, the memory storing program instructions which, when executed by the processor, cause the computing device to perform a method of managing a maintenance process in the mobile network, the method comprising:
   receiving from a first one of the distributed entities a control-level report related to a quality of service, QoS, of the first distributed entity, the first distributed entity operating the maintenance process;
   based on the control-level report, determining a first QoS status of the first distributed entity;
   in response to registration of a mobile device being handed over from a first edge node controlled by the first distributed entity to a second edge node controlled by a second one of the distributed entities:
      based on a user-level report related to the QoS of the first distributed entity and received from the mobile device, determining a second QoS status of the first distributed entity;
      if the second QoS status is indicative of a predefined QoS issue, identifying a manipulation condition of the maintenance process based on the first QoS status, and if the manipulation condition indicates a potential manipulation of the maintenance process, triggering a cleanup routine configured for removing the potential manipulation based on the manipulation condition.
17. A computer-implemented method of operating a mobile communications device, the method comprising, by the mobile communications device:
   operating a communications link to a mobile network via edge nodes of the mobile network;
   collecting diagnostic data related to related to the communications link;
   maintaining the communications link by performing a handover from a first one of the edge nodes to a second one of the edge nodes, the first edge node being controlled by a first distributed entity of the mobile network, the second edge node being controlled by a second distributed entity of the mobile network;
   in response to the handover, generating a user-level report containing a portion of the diagnostic data being related to the operation of the communications link via edge nodes controlled by the first distributed entity; and
   transmitting the user-level report to a centralized entity of the mobile network via the second distributed entity.
18. A computer program product comprising a computer readable storage medium having program instructions embodied therewith, the program instructions being executable by a mobile communications device to cause the mobile communications device to perform a method comprising:
   operating a communications link to a mobile network via edge nodes of the mobile network;
   collecting diagnostic data related to related to the communications link;
   maintaining the communications link by performing a handover from a first one of the edge nodes to a second one of the edge nodes, the first edge node being controlled by a first distributed entity of the mobile network, the second edge node being controlled by a second distributed entity of the mobile network;
   in response to the handover, generating a user-level report containing a portion of the diagnostic data being related to the operation of the communications link via edge nodes controlled by the first distributed entity; and
   transmitting the user-level report to a centralized entity of the mobile network via the second distributed entity.
19. A computing device being configured as a mobile communications device, the computing device comprising a processor and a memory, the memory storing program instructions which, when executed by the processor, cause the computing device to perform a method comprising:
   operating a communications link to a mobile network via edge nodes of the mobile network;
   collecting diagnostic data related to related to the communications link;
   maintaining the communications link by performing a handover from a first one of the edge nodes to a second one of the edge nodes, the first edge node being controlled by a first distributed entity of the mobile network, the second edge node being controlled by a second distributed entity of the mobile network;
   in response to the handover, generating a user-level report containing a portion of the diagnostic data being related to the operation of the communications link via edge nodes controlled by the first distributed entity; and
   transmitting the user-level report to a centralized entity of the mobile network via the second distributed entity.

What is claimed is:

1. A computer-implemented method of managing a maintenance process in a mobile network, the mobile network comprising a centralized entity and distributed entities, the distributed entities controlling edge nodes configured for registering mobile devices with the mobile network, the method comprising, by the centralized entity:
receiving from a first one of the distributed entities a control-level report related to a quality of service, QoS, of the first distributed entity, the first distributed entity being configured for maximizing the QoS of the first distributed entity by operating the maintenance process;
based on the control-level report, determining a first QoS status of the first distributed entity;
in response to registration of a mobile device being handed over from a first edge node controlled by the first distributed entity to a second edge node controlled by a second one of the distributed entities:
based on a user-level report related to the QoS of the first distributed entity and received from the mobile device, determining a second QoS status of the first distributed entity;
if the second QoS status is indicative of a predefined QoS issue, identifying a manipulation condition of the maintenance process based on the first QoS status, and if the manipulation condition indicates a potential manipulation of the maintenance process, triggering a cleanup routine configured for removing the potential manipulation based on the manipulation condition.

2. The method of claim 1, the manipulation condition being identified as being indicative of a potential manipulation of the maintenance process affecting the control-level report if the first QoS status is not indicative of a predefined QoS issue.

3. The method of claim 1, the identification of the manipulation condition being further based on a history dataset obtained from a knowledge base, the history dataset comprising report information being selected from the group consisting of a control-level report and a user-level report.

4. The method of claim 3, the identification of the manipulation condition being based on the history dataset if the first QoS status is indicative of a predefined QoS issue.

5. The method of claim 3, the maintenance process being part of a first setup of maintenance processes operated by the first distributed entity, the identification of the manipulation condition further comprising, if the first QoS status is indicative of a predefined QoS issue, searching a reference dataset in the knowledge base, the search comprising selecting a history dataset from the knowledge base as the reference dataset if the report information of the history dataset is descriptive of a similar distributed entity having a second setup of maintenance processes fulfilling a predefined first similarity criterion with respect to the first setup, and if the report information of the history dataset is indicative of a third QoS status of the similar distributed entity fulfilling a predefined second similarity criterion with respect to the first QoS status, the cleanup routine being further configured for removing the manipulation based on a result of the search.

6. The method of claim 5, the manipulation condition being identified as being indicative of a potential manipulation of the maintenance process based on data poisoning if the search does not result in a selection of a history dataset from the knowledge base as the reference dataset.

7. The method of claim 5, the identification of the manipulation condition further comprising, if the search results in a selection of a history dataset from the knowledge base as the reference dataset, reading a first activity parameter of the maintenance process operated by the first distributed entity from the control-level report, reading a second activity parameter of the maintenance process operated by the similar distributed entity from the reference dataset, and comparing the first activity parameter with the second activity parameter, the cleanup routine being further based on a result of the comparison.

8. The method of claim 7, the manipulation condition being identified as being indicative of a potential operational manipulation of the maintenance process if the comparison is indicative of a difference between the first activity parameter and the second activity parameter fulfilling a predefined significance criterion.

9. The method of claim 7, the manipulation condition being identified as being not indicative of a potential manipulation of the maintenance process if the comparison is not indicative of a difference between the first activity parameter and the second activity parameter fulfilling a predefined significance criterion.

10. The method of claim 3, further comprising storing the user-level report and the control-level report in the knowledge base if the manipulation condition does not indicate a potential manipulation of the maintenance process.

11. The method of claim 1, the cleanup routine comprising restarting the first distributed entity.

12. The method of claim 1, the first distributed entity being configured for collecting diagnostic data associated with operation of the first distributed entity in a first repository and for performing the operation of the maintenance process based on the diagnostic data, the cleanup routine comprising configuring the first distributed entity for diverting the collection of diagnostic data to a second repository not associated with the first distributed entity and for continuing the operation of the maintenance process based on only the diagnostic data collected in the second repository.

13. The method of claim 1, the control-level report comprising first diagnostic data being related to operation of the first distributed entity, being representative of a predefined reporting time interval and being selected from the group consisting of a number of mobile devices registered with edge nodes controlled by the first distributed entity; a number of actions performed by the maintenance process; a share of a predefined usage profile in a processor load of the first distributed entity or in a network load associated with the first distributed entity; a QoS performance achieved for the predefined usage profile; a performance indicator of the maintenance process; and a resource usage by the maintenance process or by the first distributed entity.

14. The method of claim 1, the user-level report comprising second diagnostic data being related to a communications link of the mobile device to the mobile network via edge nodes controlled by the first distributed entity, the second diagnostic data being selected from the group consisting of a signal quality indicator; a service quality indicator; a delay time; and protocol information exchanged between the mobile network and the mobile device for controlling the communications link.

15. A computer program product for managing a maintenance process in a mobile network, the mobile network comprising a centralized entity and distributed entities, the distributed entities controlling edge nodes configured for registering mobile devices with the mobile network, the computer program product comprising a computer readable storage medium having program instructions embodied therewith, the program instructions being executable by the centralized entity to cause the centralized entity to perform a method comprising:
receiving from a first one of the distributed entities a control-level report related to a quality of service, QoS, of the first distributed entity, the first distributed entity operating the maintenance process;
based on the control-level report, determining a first QoS status of the first distributed entity;
in response to registration of a mobile device being handed over from a first edge node controlled by the first distributed entity to a second edge node controlled by a second one of the distributed entities:
based on a user-level report related to the QoS of the first distributed entity and received from the mobile device, determining a second QoS status of the first distributed entity;
if the second QoS status is indicative of a predefined QoS issue, identifying a manipulation condition of the maintenance process based on the first QoS status, and if the manipulation condition indicates a potential manipulation of the maintenance process, triggering a cleanup routine configured for removing the potential manipulation based on the manipulation condition.

16. A computer-implemented method of operating a mobile communications device, the method comprising, by the mobile communications device:
operating a communications link to a mobile network via edge nodes of the mobile network;
collecting diagnostic data related to related to the communications link;
maintaining the communications link by performing a handover from a first one of the edge nodes to a second one of the edge nodes, the first edge node being controlled by a first distributed entity of the mobile network, the second edge node being controlled by a second distributed entity of the mobile network;
in response to the handover, generating a user-level report containing a portion of the diagnostic data being related to the operation of the communications link via edge nodes controlled by the first distributed entity; and
transmitting the user-level report to a centralized entity of the mobile network via the second distributed entity.
